(19) United States
(12) Patent Application Publication
(10) Pub. No.: US 2025/0148511 A1
(43) Pub. Date: May 8, 2025

(54) System and Method for Virtual Customer Service Interaction with Microservice Layer and Business Logic Module

(71) Applicants: Chantal Bacon, Palm Beach Gardens, FL (US); Ben Bacon, Plam Beach Gardens, FL (US)

(72) Inventors: Chantal Bacon, Palm Beach Gardens, FL (US); Ben Bacon, Plam Beach Gardens, FL (US)

(21) Appl. No.: 18/935,942

(22) Filed: Nov. 4, 2024

Related U.S. Application Data
(60) Provisional application No. 63/547,314, filed on Nov. 3, 2023.

(51) Int. Cl. G06Q 30/02; G06F 40/40; G10L 13/027

(52) U.S. Cl. CPC G06Q 30/0281; G06F 40/40; G10L 13/027

(57) ABSTRACT

The invention provides a method for delivering customer engagement through a metahuman concierge platform. The method includes an interface for interaction, a database layer for application data and a controller for the metahuman concierge platform. The controller includes a microservice layer with a voice module, a conversation module, an avatar module and a business logic module. The system displays a conversational agent for voice, video, or text interaction. The interface can be a mobile app, a kiosk, a web app, or a holograph. The microservice layer can include a rest API. The conversation module controls textual responses through generative large language models, and the voice module provides text to voice generation. The avatar module provides meta human features, and the business logic module incorporates functional logic for the processes.

### CROSS REFERENCE TO RELATED APPLICATION

This application claims benefit from currently pending U.S. Provisional Application No. 63/547,314 titled “System and Method for Virtual Customer Service Interaction with Microservice Layer and Business Logic Module” and having a filing date of Nov. 3, 2023, all of which is incorporated by reference herein

### BACKGROUND OF THE INVENTION

### Field of the Invention

The present disclosure generally pertains to a system and method for providing customer service through a metahuman concierge platform. Specifically, using conversational generative artificial intelligence (AI) interactions to interact with potential and existing customers.

### Description of Related Art

Customer experience through sales and service interactions with an organization is Customer experience through sales and service interactions with an organization is a critical aspect of any business, and the way it is delivered has evolved significantly with the advent of technology. As customer engagement businesses continue to be a large and vital practice in the business, there is a need for sales, service, and support to customers today through traditional engagement models which involve both human resources and digital engagement systems.

People's distrust and disdain for traditional engagement models-both human-centric and through digital mediums (chatbots, IVRs, etc.)—is highlighted by inconsistent or misguided information, ineffective communication, pushiness or impatience, lack of empathy or understanding, and (in the case of humans) long wait times or lack of responsiveness. These factors pose numerous issues for businesses striving for customer satisfaction and trust, retention, scalability, and consistency. Human capital is expensive, burdensome to obtain, time-consuming to train, and difficult to retain, creating strong headwinds to profitable, effective customer engagement through sales, service, and support milestones. Traditional digital solutions are narrowly-limited and frequently struggle to address anything beyond basic, pre-defined issues.

In recent years, the use of alternative, digital mediums for customer service has gained popularity. These virtual systems, often powered by AI, can interact with customers through various interfaces such as mobile apps, web apps, kiosks, and even holograms. They can provide immediate responses, operate ceaselessly, and handle multiple queries simultaneously, thereby improving efficiency and customer satisfaction. However, the development and operation of these products involve complex processes and systems that challenge the effective integration of virtual customer service functions.

For instance, the avatar module may not provide realistic human features, and the chat and voice modules may not generate natural-sounding responses. Moreover, the business logic module may rely on predefined decision trees, which can limit the flexibility and adaptability of the virtual representative. Furthermore, the integration of these systems and modules can be complex and may not always be efficient or effective. Therefore, there is a need for an improved method for providing customer service through a virtual representative.

To reduce the complexity and length of the Detailed Specification, and to fully establish the state of the art in certain areas of technology, Applicant(s) herein expressly incorporate(s) by reference all of the following materials identified in each numbered paragraph below. The incorporated materials are not necessarily “prior art.”
U.S. Pat. No. 9,819,700B2
US20090276704A1
U.S. Pat. No. 10,673,787B2
US20220301250A1
US20220366913A1
U.S. Pat. No. 10,817,667B2
US20220350460A1
U.S. Pat. No. 10,666,582B2
U.S. Pat. No. 10,616,147B2
U.S. Pat. No. 11,240,179B2

Applicant(s) believe(s) that the material incorporated above is “non-essential” in accordance with 37 CFR 1.57 because it is referred to for purposes of indicating the background of the invention or illustrating the state of the art. However, if the Examiner believes that any of the above-incorporated material constitutes “essential material” within the meaning of 37 CFR 1.57 (c) (1)-(3), the applicant(s) will amend the specification to expressly recite the essential material that is incorporated by reference as allowed by the applicable rules.

### BRIEF SUMMARY OF THE INVENTION

The present invention provides among other things a method for providing customer engagement through a metahuman concierge platform. The method includes the provision of an interface for interaction between the metahuman concierge platform and a customer, and the creation of a database layer containing application data. The metahuman concierge platform is controlled by a controller that includes a microservice layer with a voice module, a conversation modul, an avatar module, and a business logic module. A message caching bus is engaged to relay information between the database layer and the microservice layer. The interface displays a conversational agent for voice, video, or text interaction with the customer. The interface can be a mobile app, a kiosk, a web app, or a hologram. The microservice layer can further include a rest API. The controller synchronizes call and return functions to each microservice layer so that the finished avatar interaction that is presented through the interface is smooth and conversational. The conversation module controls the textual responses of the conversation agent through generative large language models, while the voice module provides incoming and outgoing text to voice generation through the same models. The avatar module provides human-like features, which can include skin color, animation, and rendering properties. The business logic module incorporates business functional logic for the processes and does not have a predefined decision tree. The video module provides incoming video detection against large language models. The metahuman concierge platform mimics consciousness, and is capable of interacting with users across nearly 150 languages and dialects.

Customer engagement can be provided for a variety of sectors including a medical office, a legal office, a manufacturing industry, an insurance provider, a government agency, or an academic institution. The method can further include providing an integration API.

It is an object of the invention to provide improved customer engagement outcomes without direct human-to-human interactions.

It is another object of the invention to provide a conversational customer engagement experience through AI and machine learning (ML).

It is another object of the invention to provide improved customer engagement without a predetermined decision tree.

It is another object of the invention to allow AI large language models (LLMs) and business logic parameters to dictate conversational customer engagement interactions.

It is another object of the invention to provide a non-human metahuman concierge who can provide a personalized conversational experience.

It is another object of the invention to provide digitally rendered artificial human assistance without a predetermined decision tree.

It is another object of the invention to provide a metahuman concierge that understands the language spoken, tone, accent, and voiceprint of the incoming voice.

It is another object of the invention to provide a metahuman concierge that provides an emotional output in tone, pitch, and context with a native accent.

It is another object of the invention to provide a metahuman concierge that processes human movement and body language.

It is another object of the invention to provide a metahuman concierge that creates continuity through facial recognition.

It is another object of the invention to provide a metahuman concierge with a dynamic recognition engine that identifies and responds to tone and body language rapidly.

It is another object of the invention to provide a metahuman concierge that interacts with back-office applications and processes.

It is another object of the invention to provide a metahuman concierge with a localized multimodal LLM.

The above and other objects may be achieved using methods involving providing customer engagement through a metahuman concierge platform. This method includes the provision of an interface for interaction between the metahuman concierge platform and a customer, the creation of a database layer containing application data, and a controller for the metahuman concierge platform. The controller includes a microservice layer with a voice module, a conversation module, an avatar module, and a business logic module. A message caching bus is engaged to relay information between the database layer and the microservice layer, and a conversational agent is displayed for voice, video, or text interaction through the interface.

The interface can be a mobile app, a kiosk, a web app, or a holograph. The microservice layer can further comprise a rest API. The controller synchronizes call and return functions that represent the finished avatar presentation to the interface. The conversation module controls the textual responses of the conversation agent through generative large language models, while the voice module provides incoming and outgoing text to voice generation through the same models. The avatar module provides meta human features, which can include skin color, animation, and rendering properties. The business logic module incorporates business functional logic for the processes and does not have a predefined decision tree. The video module provides incoming video detection against large language models. Customer engagement can be provided for a medical office, a legal office, a manufacturing industry, or an academic institution. The method can further comprise providing an integration API.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain, and ordinary meaning of the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material, or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF THE SEVERAL VIEWS OF THE DRAWINGS

A more complete understanding of the present invention may be derived by referring to the detailed description when considered in connection with the following illustrative figures. In the figures, like reference numbers refer to like elements or acts throughout the figures.

FIG. 1 depicts an overall schematic view of the method according to one embodiment of the invention.

FIG. 2 depicts a schematic view of the voice microservice of the embodiment of FIG. 1.

FIG. 3 depicts a schematic view of the chat microservice of the embodiment of FIG. 1.

FIG. 4 depicts a schematic view of the avatar microservice of the embodiment of FIG. 1; and

FIG. 5 depicts a schematic view of the business logic-RAG model of the embodiment.

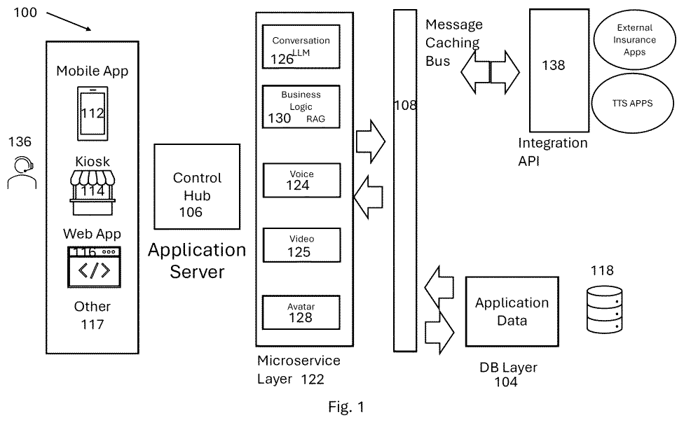

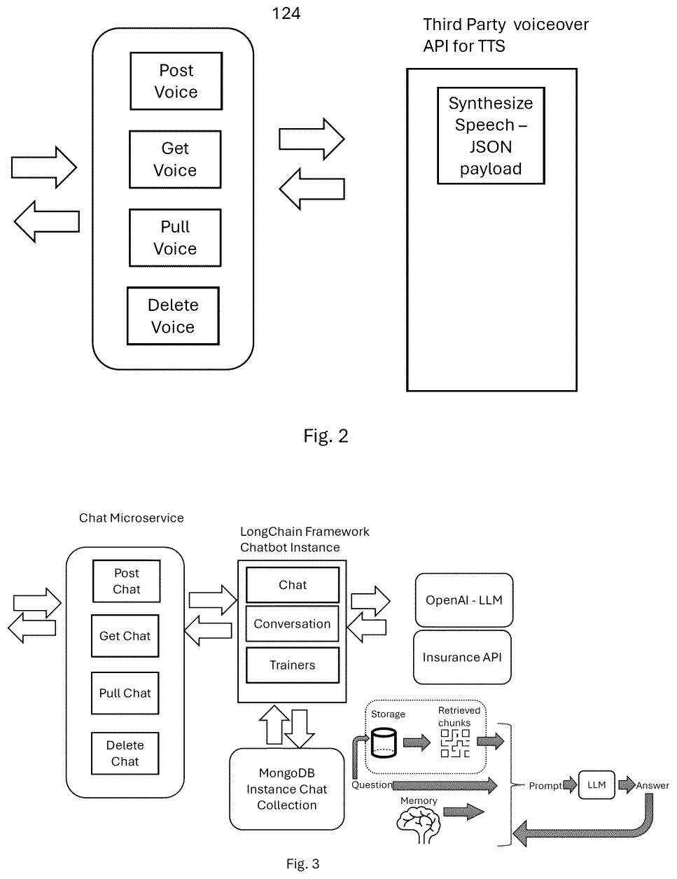

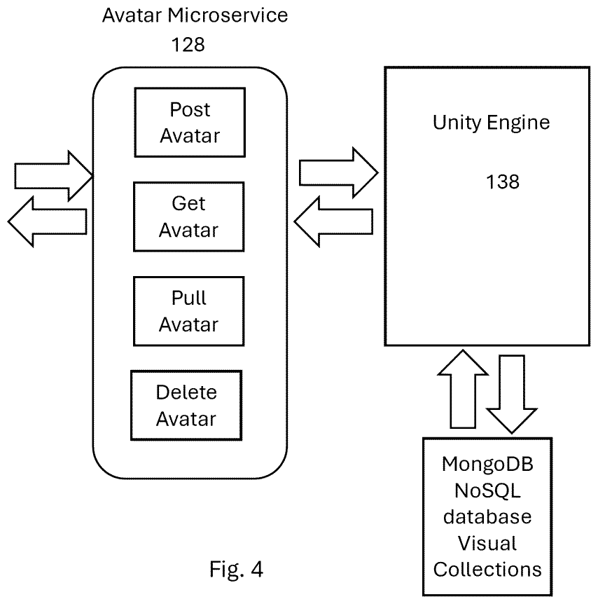

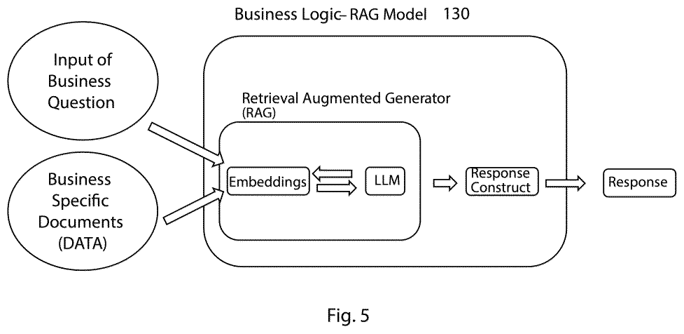

Elements and acts in the figures are illustrated for simplicity and have not necessarily been rendered according to any particular sequence or embodiment.

### DETAILED DESCRIPTION OF THE INVENTION

In the following description, and for the purposes of explanation, numerous specific details are set forth to provide a thorough understanding of the various aspects of the invention. It will be understood, however, by those skilled in the relevant arts, that the present invention may be practiced without these specific details. In other instances, known structures and devices are shown or discussed more generally to avoid obscuring the invention. In many cases, a description of the operation is sufficient to enable one to implement the various forms of the invention, particularly when the operation is to be implemented in software. It should be noted that there are many different and alternative configurations, devices, and technologies to which the disclosed inventions may be applied. The full scope of the inventions is not limited to the examples that are described below.

In one application of the invention, the proposed method for providing customer engagement involves an interface 102, a database layer 104, a controller 106 for a metahuman concierge platform 100, a message caching bus 108, and a conversational agent 110. The interface 102, can take the form of a mobile app 112, a kiosk 114, a web app 116, or a holograph. This interface allows a metahuman concierge platform 100 to interact with a customer, providing a platform for voice, video, or text interaction.

The database layer 104 is created to contain application data 120 and is an intermediary between the business logic and the database 118 that stores and retrieves the data. This data can include customer information, transaction history, and other relevant data that the metahuman concierge platform may need to access during the interaction.

The controller 106 for the metahuman concierge platform includes a microservice layer 122 with a voice module 124, a conversation module 126, an avatar module 128, and a business logic module 130. The voice module 124 provides incoming and outgoing text to voice generation through generative large language models 132. The conversation module 126 controls textual responses of the conversation agent through generative large language models 132 and the avatar module 128 provides meta human features, which can include skin color, animation, and rendering properties. A Unity engine 138 and NoSQL database such as MongoDB may be provided to support the interactive experience in the avatar module.

The business logic module 130 incorporates business functional logic for the processes. Business logic is responsible for ensuring that a business's processes and workflows are implemented correctly, efficiently, and in accordance with the organization's policies and rules. These rules can be related to pricing, inventory management, order processing, user access control, and many other aspects of the business and may involve the manipulation and processing of data. The business logic module 130 may define the sequence of steps or actions that need to be taken to accomplish a particular business process including decisions, branching, and conditional logic to handle various scenarios. The business logic 130 may be separated from the user interface 102 and data storage components of a software application.

The controller 106 also includes a rest API 134 that synchronizes call and return functions that will represent the finished avatar presentation 136 to the interface 102. The message caching bus 108 is engaged to relay information between the database layer 104 and the microservice layer 122. This ensures that the metahuman concierge platform 100 has access to the most up-to-date information and can provide accurate responses to the customer. The conversational agent 110 is displayed to have a conversational voice, video, or text interaction through the interface.

This agent 110 can provide customer engagement for a variety of settings, including a medical office, a legal office, a manufacturing industry, or an academic institution. The business logic module 130 does not have a predefined decision tree, allowing for more flexibility and adaptability in the customer engagement process. The business logic module 130 may incorporate RAG business logic parameters. RAG is a natural language processing (NLP) and machine learning technique that combines retrieval and generation to enhance the quality and relevance of text generation tasks such as question answering, content generation, and chatbot responses.

In the retrieval step, a system or model searches through a large collection of pre-existing text, which can be a knowledge base, a database 118, a set of documents, or the internet. The goal is to find relevant information or context that can be used to generate a response or content. After retrieving relevant information, the system generates a response or content using that retrieved context. This can involve various text generation techniques, including rule-based systems, template filling, or more advanced methods like neural language models. Retrieval ensures that the generated content is based on existing knowledge or information, making it factually accurate and contextually relevant. Generation allows for creativity, coherence, and flexibility in constructing responses.

Finally, the method also includes providing an integration API 138. This allows the system to be integrated with other software or systems, further enhancing its functionality and versatility. For example, to simplify routine tasks, the metahuman concierge platform 100 can initiate workflows across different departments. For example, if a customer requests a refund, the metahuman concierge platform 100 can directly engage with inventory and accounting systems, updating stock or beginning the reimbursement process without needing human intervention. By linking with a CRM system, the metahuman concierge platform 100 can also log each interaction, add notes, and flag follow-up actions, ensuring that customer records are always up-to-date and accessible. This integration with CRM tools also opens up opportunities for personalized engagement, as the metahuman concierge platform 100 can access purchase data to make recommendations or suggest complementary products, all tailored to the customer's preferences.

For transactions, the metahuman concierge platform 100 securely manages payments, refunds, and subscriptions by connecting with payment processing systems. Its integration with inventory management systems allows it to check product availability, confirm shipping estimates, or even provide location-specific stock details, helping customers get real-time updates on the items they're interested in. If the metahuman concierge platform 100 encounters a more complex request, it can create a support ticket and provide human agents with detailed context, allowing them to resolve the issue quickly when they step in.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. The terms “including” and “such as” are not limiting and should be interpreted as “including, but not limited to,” and “such as, for example,” respectively. Moreover, any combination of the above-described embodiments in all possible variations thereof is encompassed by the disclosure unless otherwise indicated herein or otherwise clearly contradicted by context.

We claim:

1. A method for providing customer engagement comprising the acts of:
providing an interface for allowing a metahuman concierge platform to interact with a customer;
creating a database layer containing application data;
providing a controller for the metahuman concierge platform including a microservice layer with a voice module, a conversation module, an avatar module, and a business logic module; engaging a message caching bus to relay information between the database layer and the microservice layer; and
displaying a conversational agent to have a conversational voice, video, or text interaction through the interface.

2. The method of claim 1, wherein the interface is at least one of a mobile app, a kiosk, a web app, and a holograph.

3. The method of claim 1, wherein the Microservice layer further comprises a rest API.

4. The method of claim 1, wherein the controller synchronizes call and return functions that will represent the finished avatar presentation to the interface.

5. The method of claim 1, wherein the conversation module controls textual responses of the conversation agent through generative large language models.

6. The method of claim 1, wherein the voice module provides incoming and outgoing text to voice generation through generative large language models.

7. The method of claim 1, wherein the avatar module provides meta human features.

8. The method of claim 1, wherein the meta human features include at least one of skin color, animation, and rendering properties.

9. The method of claim 1, wherein the business logic module incorporates business functional logic for the processes.

10. The method of claim 1, wherein the video module provides incoming video detection against large language models.

11. The method of claim 1, wherein the customer engagement is provided for a medical office, a legal office, a manufacturing industry, or an academic institution.

12. The method of claim 1, wherein the business logic module does not have a predefined decision tree.

13. The method of claim 1, further comprising providing an integration API.

14. A system for providing customer engagement, comprising:
an interface for allowing a metahuman concierge platform to interact with a customer;
a database layer containing application data;
a controller for the metahuman concierge platform, the controller including a microservice layer with a voice module, a conversation module, an avatar module, and a business logic module;
a message caching bus configured to relay information between the database layer and the microservice layer; and
a conversational agent configured to have conversational voice, video, or text interactions with the customer through the interface.

15. The system of claim 12, wherein the interface is at least one of a mobile app, a kiosk, a web app, and a holograph.

16. The system of claim 12, wherein the microservice layer further comprises a REST API.

17. The system of claim 12, wherein the controller is configured to synchronize call and return functions representing the finished avatar presentation on the interface.

18. The system of claim 12, wherein the voice module provides incoming and outgoing text-to-voice generation using generative large language models.

19. The system of claim 12, wherein the business logic module incorporates business functional logic for processes.

20. The system of claim 12, wherein the business logic module does not use a predefined decision tree.
